(19) United States
(12) Patent Application Publication
(10) Pub. No.: US 2005/0005786 A1
(43) Pub. Date: Jan. 13, 2005

(54) Storage system for ink stamps

(76) Inventor: Mark E. Armstrong, Hermon, ME (US)

Correspondence Address: BOHAN, MATHERS & ASSOCIATES, LLC, PO BOX 17707, PORTLAND, ME, 04112-8707, US

(21) Appl. No.: 10/692,710

(22) Filed: Oct. 23, 2003

Related U.S. Application Data
(63) Continuation-in-part of application No. 10/615,578, filed on Jul. 8, 2003, now abandoned.

(51) Int. Cl. B31F 1/07

(52) U.S. Cl. 101/3.1

(57) ABSTRACT

An ink-stamp storage system for magnetically storing ink stamps. The storage system has a storage panel with a strip of ferrous metal. The ink stamps are provided with a magnet and are magnetically mountable on the storage panel. One type of storage system is a rack that has a rotatable base element with multiple storage panels mounted on the base element; another type of storage system has a flat base with a single storage panel fixedly attached to the base. An anti-slip means is provided on the underside of the flat base, to prevent the base from inadvertently moving across a desk-top surface.

### BACKGROUND INFORMATION

1. Field of the Invention

The invention relates to a system for organizing and storing ink stamps. More particularly, the invention relates to a rack for holding various types of ink stamps.

2. Description of the Prior Art

The ink stamp is used quite commonly to imprint a message or signature on a document or an object. A business will often require the use of any number of ink stamps in the normal course of business. Some people may routinely use upwards of 20 ink stamps. With more than just a few such stamps, it becomes difficult to organize the stamps so that they are readily identifiable and accessible for use. The difficulty is compounded by the fact that ink stamps come in a variety of sizes, shapes, and types. Some stamps have a stamp base and a handle with a knob on the end of the handle to facilitate storage of the stamp in a conventional stamp rack designed to support the knob. There are stamps that ink themselves such as self-inking stamps, pre-inked stamps and flash or instant stamps. Self-inking stamps are typically enclosed in a rectangular housing and cannot be stored on the conventional stamp rack. Where necessary to differentiate between two types of stamps, a stamp with a handle will be referred to as a “handle” stamp and all types of stamps that ink themselves will be referred to as a “self-inking” stamp. What happens generally is that the handle stamps are stored on a rack and the self-inking stamps in a box or simply on the top of the desk. Thus, the stamps are not organized in a rational manner according to subject matter or sequence of usage, but rather, by size or type, i.e., handle stamps are stored separately, although both types of stamps may be used within a particular work process. Furthermore, the racks may occupy a great deal of precious desktop space.

Bertoni et al. (U.S. Pat. No. 6,510,951; 2003) discloses a tree-like holder for self-inking stamps. The holder has branches that extend outward from which self-inking stamps are hung. Each branch has a “main” branch and an “auxiliary” branch, and a self-inking stamp is secured to the holder by sliding it between a “main” branch and the corresponding auxiliary branch. The disadvantage of this type of rack is that it holds only self-inking types of stamps. The organizational problem of keeping stamps together that are used within a particular work process is not solved by having separate storage systems for the different types of ink stamps. Furthermore, quick removal of a stamp is difficult if it is located in the middle of a “branch,” because other stamps must be removed in order to reach it. While retrieving one stamp, other stamps can also become accidentally dislodged from the holder. Additionally, it is not easy to recognize each stamp because the holder may hide the labels.

It is desirable to store self-inking stamps magnetically. Wright (U.S. Pat. No. 4,626,218; 1986) discloses an architect's furniture design aid that includes a kit having a foldable surface that serves to represent the wall surface of a room, and miniature, modular blocks that represent furniture items. The walls have a metallic, magnetically attractive coating and each miniature block that has a rubber stamp on at least one face that depicts the particular piece of furniture or appliance it represents. The block has a magnet attached to it and is magnetically held in place on one of the walls when the architect is planning the room. A disadvantage of the kit is that it, being an architect's model, is constructed to map out a certain room space and simply provides three walls. Thus, it does not provide an aid for organizing stamps, nor does it provide an space-efficient means for storing ink stamps, as it is constructed to take up a lot of desk or shelf space. Also, because of the way the stamps are mounted on the wall surfaces, it would be clumsy for users to quickly retrieve a particular stamp.

What is needed, therefore, is a system of organizing and storing ink stamps. What is further needed is such a system that enables self-inking and “handle” stamps to be stored together. What is yet further needed is such a system that provides direct and quick access to each individual stamp stored within the system. What is still yet further needed is such a system that occupies minimal space on a desktop.

### BRIEF SUMMARY OF THE INVENTION

For the reasons cited above, it is an object of the present invention to provide a system of organizing and storing ink stamps. It is a further object to provide such a system that enables self-inking and handle stamps to be stored together. It is a yet further object to provide such a system which enables direct and quick access to each individual stamp. It is still yet further an object to provide such a system that does not require space on a desktop or, if it is placed on the desktop, occupies minimal space.

The objects of the invention are achieved by providing a stamp storage system that holds magnetically equipped ink stamps. The system includes a panel with a metallic sheet or strip. Each stamp to be stored in the storage system has a magnet mounted on the surface. When storing the ink stamp, it is simply placed on the metallic strip, where it is magnetically held in place. Some stamps incorporate magnets in their operation, e.g., magnets are used to hold the letters, numbers, symbols, etc. to the stamp face. These stamps may also be stored in the storage system according to the invention.

The invention includes several embodiments of the stamp storage system. Each embodiment allows for the storage of stamps of various sizes, shapes and/or types, such as handle stamps or self-inking stamps. One embodiment of the system is as a storage rack having a rotatable base and a number of storage panels that extend vertically about the base. The ink stamps may be stored on the various panels according to use or size. In another embodiment, the system includes a wall-mountable panel with a storage panel on it. The wall-mountable panel may be mounted on various types of wall surfaces, such as drywall and fabric cubicle surfaces. A further embodiment comprises a slender desktop stand that occupies minimal space on a desk.

### BRIEF DESCRIPTION OF THE DRAWINGS

FIG. 1 is an elevational view of a first embodiment of the ink stamp storage system according to the invention.

FIG. 2 is a top view of the ink stamp storage system of FIG. 1.

FIG. 3A is an illustration of a magnetically equipped self-inking stamp.

FIG. 3B is an illustration of a magnetically equipped handle stamp

FIG. 4 is an elevational view of a second embodiment of the ink stamp storage system according to the invention.

FIG. 5A is a perspective view of a third embodiment of the ink stamp storage system according to the invention.

FIG. 5B is a side view of the system of FIG. 5A.

FIG. 5C is a side view of the system of FIG. 5A.

### DETAILED DESCRIPTION OF THE INVENTION

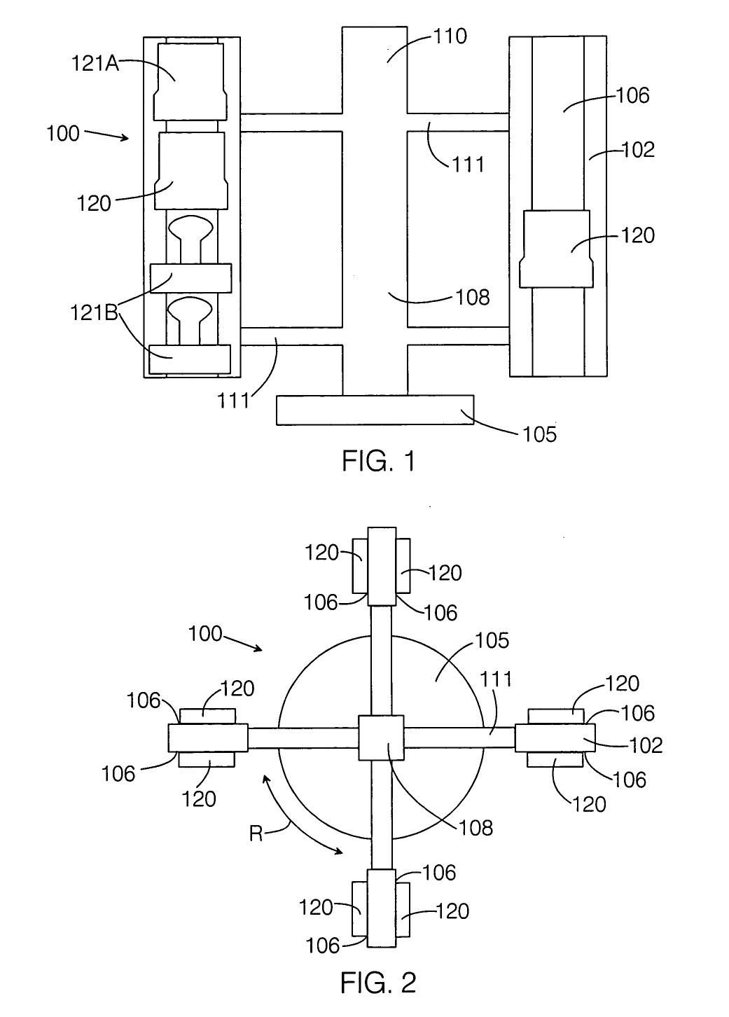

FIGS. 1 and 2 illustrate a first embodiment of an ink stamp storage system 100 according to the invention. FIG. 1 is an elevational view showing a storage rack 110 and an ink stamp 120. The storage rack 110 comprises a base 105, a stem 108, and a plurality of storage panels 102 that extend radially outward from the stem 108. A metallic strip 106 of ferrous metal is affixed to each storage panel 102. In the embodiment shown in FIGS. 1 and 2, the storage panel 102 is fixedly attached to the stem 108 by an arm 111. The stem 108 is rotatably connected to the base 105. Many means of rotation are known, such as a “lazy susan” or simply a combination of an outer cylinder rotating about a fixed rod or shaft. Any suitable means of rotation is included within the scope of the invention. A magnetically equipped stamp 120 is held by the magnetic force on the metallic strip 106. Both self-inking stamps 121A and handle stamps 121B may be stored with the storage system 100 according to the invention. Rotating the stem 108, indicated by direction of rotation arrow R, provides better access to the magnetically equipped stamps 120.

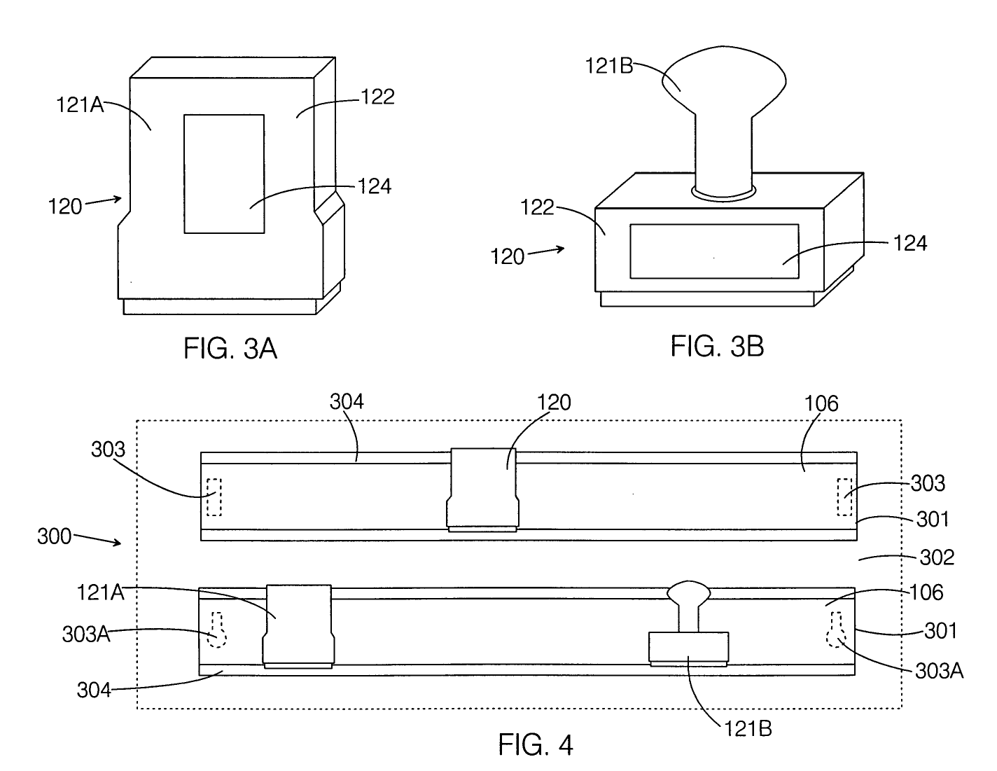

FIGS. 3A and 3B illustrates different types of the ink stamp 120 according to the invention. In FIG. 3A, the ink stamp 120 is a self-inking stamp 121A; in FIG. 3B it is a non-self-inking or handle stamp 121B. The ink stamp 120 has a mounting face 122 that includes a magnet 124, preferably a high strength magnet. The magnet 124 may be incorporated into the housing when the ink stamp 120 is manufactured or may be applied to existing ink stamps by means of a conventional high-strength adhesive.

FIG. 4 is an elevational view of a second embodiment of an ink stamp storage system 300 according to the invention. In this embodiment, a wall-mountable strip panel 301 comprises the metallic strip 106, which may be mounted on a suitable substrate 304, such as a wood or a plastic panel for decorative purposes. The wall-mountable strip panel 301 is mounted on a wall surface 302 using wall fasteners 303/303A. The wall surface 302 may be a conventional wall or a fabric surface of a conventional office cubicle wall. It should be understood that any type of suitable wall fastener 303 is included within the scope of the invention. For example, a strip having the hook portion of a conventional hook-and-loop type fastener, such as VELCRO®, is particularly effective and suitable for use on fabric cubicle walls. Dry wall screws, anchors, or adhesive may also be used to fasten the panels to the conventional wall. In the embodiment shown, the wall fastener 303 is a piece of VELCRO® adhesively attached to the back of the wall-mountable strip panel 301 and 303A is a recessed area for suspending the wall-mountable strip panel 301 on the wall 302 from screws. The wall-mountable strip panels 301 are particularly useful for mounting the ink stamp storage system 300 in convenient locations at a workstation and, depending on the particular needs, provide greater versatility because multiple strip panels 301 may be mounted in various configurations on the wall surface 302.

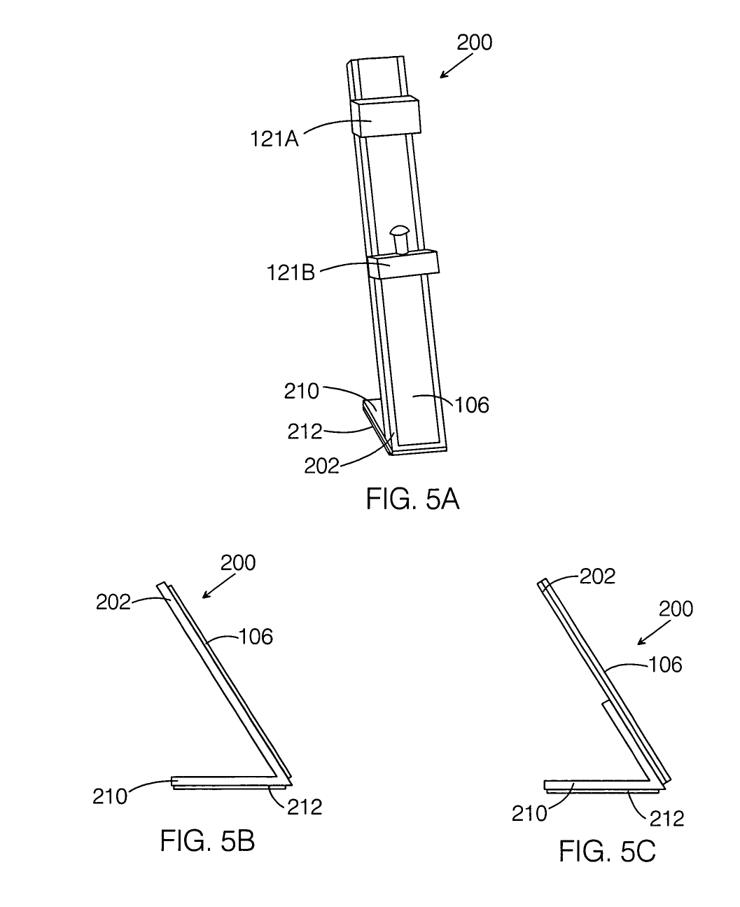

FIGS. 5A-5C illustrate a third embodiment of an ink-stamp storage system 200 according to the invention. The system 200 comprises a base 210 and a free-standing panel 202 that extends upward from the base 210. The panel 202 may be constructed of a strip of metallic material, such as the metallic strip 106, or of a non-magnetic material to which the metallic strip 106 is affixed or a metallic coating is applied. In the embodiment shown, the base 210 and the panel 202 are made of acrylic material and the metallic strip 106 is affixed to the panel 202. The base 210 and the panel 202 may be formed of a single piece of material, as shown in FIG. 5B, or be separate pieces that are fixedly attached to each other, as shown in FIG. 5C. The underside of the base 210 preferably includes an anti-slip means 212 to prevent the ink-stamp storage system 200 from moving unintentionally on the desktop surface. The anti-slip means 212 may be a conventional pad of adhesive material that is removable and/or re-usable and that is affixed to the bottom surface of the base 210, such as a double-sided adhesive pad. Further, the anti-slip means 212 may be material that is permanently applied to the base 210, or the base 210 itself may be made of an anti-slip material. Other suitable anti-slip means include a coating of soft, gummy or rubbery material that is applied to the base.

It is understood that the embodiments described herein are merely illustrative of the present invention. One skilled in the art may contemplate variations in the construction of the invention without limiting the intended scope of the invention herein disclosed and as defined by the following claims.

1. A system for storing ink stamps, said system comprising:
a storage rack having a first magnetic mount component; and
an ink stamp having a second magnetic mount component and being adapted to be mountable on said storage rack.

2. The system of claim 1, wherein said first magnetic mount component is a magnetically attractive material and said second magnetic mount component is a permanent magnet.

3. The system of claim 1, wherein said first magnetic mount component is a permanent magnet and said second magnetic mount component is a magnetically attractive material.

4. The system of claim 1, wherein said storage rack is a table-top rack having a base and a storage panel.

5. The system of claim 4, wherein said storage rack includes a storage panel having a first side and a second side, and wherein said first side and said second side are each equipped with said first magnetic component and said ink stamp is magnetically mountable on said first side and/or said second side.

6. The system of claim 5, wherein said storage panel includes multiple storage panels.

7. The system of claim 4, wherein said storage panel is rotatably mounted on said base.

8. A system for storing ink stamps, said system comprising:
a wall-mountable storage strip comprising a first magnetic mount component, wherein said storage strip is adapted to be mountable on a wall; and
an ink stamp having a second magnetic mount component and adapted to be mountable on said storage strip.

9. The system of claim 8, further comprising a wall-mounting means for mounting said storage strip on a wall.

10. The system of claim 9, wherein said wall is a fabric wall and said wall-mounting means is a fastener.

11. The system of claim 8, wherein said storage strip includes a substrate on which said first magnetic mount component is mounted.

12. An ink stamp having a mounting face said ink stamp comprising a permanent magnet assembled in said mounting face.

13. The ink stamp of claim 12, wherein said ink stamp is a self-inking stamp.

14. The ink stamp of claim 12, wherein said ink stamp is a non-self-inking stamp with a handle.

15. A storage rack for holding magnetic items, said storage rack comprising a base, a storage panel, and an anti-slip means;
wherein said storage panel is a substantially flat panel having a metallic storage panel surface containing ferrous material,
wherein said storage panel is fixedly attached to said base and extends upward from said base at an angle between 45 degrees and 90 degrees, and
wherein said anti-slip means is provided on a bottom surface of said base.

16. The storage rack of claim 15, wherein said base and said flat panel are constructed as a single piece of acrylic material and said storage panel surface is a metallic strip that is adhesively attached to said flat panel.

17. The storage rack of claim 15, wherein said anti-slip means is a two-sided adhesive pad that is attached to said bottom surface of said base, and wherein at least one side of said two-sided adhesive pad is coated with a reusable adhesive.
